(19) United States
(12) Patent Application Publication
(10) Pub. No.: US 2017/0262188 A1
(43) Pub. Date: Sep. 14, 2017

(54) METHOD FOR MANAGING MAIN MEMORY DATABASE

(71) Applicant: TmaxData Co., Ltd, Gyeonggi-do (KR)

(72) Inventors: Se Hoon SEO, Seoul (KR); Sung Wook MOON, Sejong (KR); Young Jae CHOI, Gyeonggi-do (KR); Sang Young PARK, Gyeonggi-do (KR)

(21) Appl. No.: 15/085,874

(22) Filed: Mar. 30, 2016

(30) Foreign Application Priority Data
Mar. 8, 2016 (KR) 10-2016-0027529

(51) Int. Cl. G06F 3/06

(52) U.S. Cl. CPC G06F 3/0608; G06F 3/0631; G06F 3/064; G06F 3/0647; G06F 3/0673

(57) ABSTRACT

An exemplary embodiment of the present disclosure discloses a management method of a main memory database which is performed in a computing apparatus including one or more processors and a main memory which stores commands executable in the processors. The main memory includes two or more regions which include a first region and a second region and the management method of a main memory database includes: allocating a part of the first region to a first version which is the oldest version among a plurality of versions of data to locate the first version in the first region of the main memory; allocating a part of the second region to a second version which is a subsequent version to the first version among a plurality of versions of data to locate the second version in the second region of the main memory; and linking the first version and the second version to generate a version chain, the first version and the second version may be configured by a header which identifies the data and the version and a data field including data.

### TECHNICAL FIELD

The present disclosure relates to a database management method, and more particularly, to a management method of a main memory database.

### BACKGROUND ART

A database is classified into a main memory database and a disk database, depending on a main storage location of data. The main memory database locates data on a main memory to minimize disk input/output (I/O), thereby showing a higher performance than that of the disk database.

Even though the main memory database may show a higher performance than that of the disk database, the main memory database may have a fragmentation problem caused by frequent modification of the database.

When the fragmentation is generated, the corresponding space is not used so that a capacity of a storage space is uselessly wasted and the data is not continuously written so that the performance may be lowered.

When a large size of reading/writing operation is performed, for example, the entire database is updated, the data may not be continuously written due to fragmented pieces.

Even though a price of a memory module is lowered, when it is considered that the price is still higher than a price of a disk drive, the problem caused by the fragmentation may lower economic feasibility of the main memory database.

Therefore, there may be a demand on a management method of a main memory database which may minimize the fragmentation, in the field of the art.

U.S. Pat. No. 6,457,021 discloses contents concerning data consistency when data of a main memory database is modified.

### SUMMARY OF THE INVENTION

The present disclosure has been made in an effort to provide a solution for increasing a performance and economic feasibility by reducing fragmentation of a main memory database.

An exemplary embodiment of the present disclosure discloses a management method of a main memory database which is performed in a computing apparatus including one or more processors and a main memory which stores commands executable in the processors. The main memory includes two or more regions which include a first region and a second region. The management method of a main memory database includes: allocating a part of the first region to a first version which is the oldest version among a plurality of versions of data to locate the first version in the first region of the main memory; allocating a part of the second region to a second version which is a subsequent version to the first version among a plurality of versions of data to locate the second version in the second region of the main memory; and linking the first version and the second version to generate a version chain, in which the first version and the second version may be configured by a header which identifies the data and the version and a data field including data.

Alternatively, the header may include at least one of a flag which represents a usage state of the version, version identification information which identifies the version, a time stamp, and data identification information which identifies data.

Alternatively, the method may further include retrieving a version located in the first region when data of the main memory database is retrieved.

Alternatively, the method may further include reading the second version located in the second region along a link of a version located in the first region when a version which is located in the first region is identified.

Alternatively, the method may further include performing garbage collection (GC) on the main memory database.

Alternatively, the performing of garbage collection may include identifying versions to be deleted by the garbage collection among the plurality of versions of the data; deleting versions which are identified to be deleted; and moving the oldest version to the first region when the oldest version among the plurality of versions of the data is located in the second region, based on the version of the data.

Alternatively, the versions to be deleted by the garbage collection may include versions excluding at least one of the latest version and a version in use among the plurality of versions of data.

Alternatively, the first region may be a region in which the oldest version of the version link for the data is located and the second region may be a region in which versions after the oldest version of the version chain for the data are located.

Another exemplary embodiment of the present disclosure discloses a computing apparatus including a main memory database.

The computing apparatus may include one or more processors; and the main memory which stores a database and includes two or more regions including a first region and a second region, the one or more processors may include: a data recording module which allocates a part of the first region to a first version which is the oldest version among a plurality of versions of data to locate the first version in the first region of the main memory and allocates a part of the second region to a second version which is a subsequent version to the first version among a plurality of versions of data to locate the second version in the second region of the main memory; and a version link module which links the first version and the second version to generate a version chain, and the first version and the second version may be configured by a header which identifies the data and the version and a data field including data.

Another exemplary embodiment of the present disclosure discloses a computer program which includes a plurality of commands executed by one or more processors and is stored in a computer readable medium.

The main memory includes two or more regions which include a first region and a second region. The computer program may include a command for allocating a part of the first region to a first version which is the oldest version among a plurality of versions of data to locate the first version in the first region of the main memory; a command for allocating a part of the second region to a second version which is a subsequent version to the first version among a plurality of versions of data to locate the second version in the second region of the main memory; and a command for linking the first version and the second version to generate a version chain, and the first version and the second version may be configured by a header which identifies the data and the version and a data field including data.

According to the present disclosure, fragmentation of the main memory database is reduced to provide a solution to increase a performance and economic feasibility.

### BRIEF DESCRIPTION OF THE DRAWINGS

FIG. 1 is a block diagram of a computing apparatus including a main memory database according to an exemplary embodiment of the present disclosure.

FIG. 2 is a vie illustrating a configuration of a version of data according to an exemplary embodiment of the present disclosure.

FIG. 3 is a view illustrating a plurality of data including a plurality of versions according to an exemplary embodiment of the present disclosure.

FIGS. 4A to 4D are views illustrating a process of performing garbage collection on a plurality of data including a plurality of versions according to an exemplary embodiment of the present disclosure.

FIG. 5 is a flowchart illustrating a management method of a main memory database according to an exemplary embodiment of the present disclosure.

FIG. 6 illustrates a simple and general schematic view of an exemplary computing environment in which exemplary embodiments of the present disclosure are embodied.

### DETAILED DESCRIPTION

Various exemplary embodiments will be described with reference to the drawings and like reference numerals denote like components throughout the drawings. In the specification, various descriptions are suggested to provide understanding of the present disclosure. However, it is obvious that the exemplary embodiments may be embodied without having the specific description. In other examples, known structures and devices are provided as a block diagram to easily describe the exemplary embodiments.

The term such as “component”, “module”, or “system” used in the specification indicates a computer-related entity, hardware, firmware, software, a combination of software and hardware, or execution of software. For example, a component may be a processing step which is executed in a processor, a processor, an object, an execution thread, a program and/or a computer, but is not limited thereto. For example, both an application which is executed in a computing apparatus and a computing apparatus may be a component. One or more components may be stayed in a processor and/or an executing thread, one component may be localized in one computer or distributed between two or more computers. Such components may be executed from various computer readable media having various data structures stored therein. The components may communicate with each other through local and/or remote processings in accordance with a signal (for example, data through other systems and a network such as the Internet through data and/or a signal from one component which interacts with other components in a local system or a distributed system) having one or more data packets.

Description of the suggested exemplary embodiment is provided to allow those skilled in the art to use or embody the present disclosure. Various modifications of the exemplary embodiments may be apparent to those skilled in the art and general principles defined herein may be applied to other exemplary embodiments without departing from the scope of the present disclosure. Therefore, the present disclosure is not limited to the exemplary embodiments suggested herein, but interpreted in a broadest range which is consistent with principles suggested herein and new features.

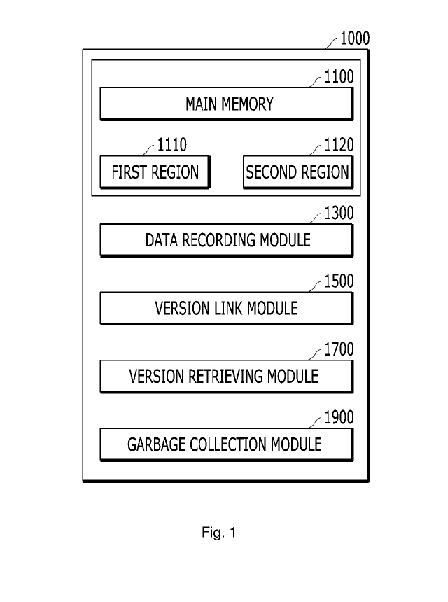

FIG. 1 is a block diagram of a computing apparatus including a main memory database according to an exemplary embodiment of the present disclosure.

A computing apparatus 1000 according to an exemplary embodiment of the present disclosure may include a computing apparatus which accepts connection of a plurality of clients such as a server, a main frame computer, or a work station.

The computing apparatus 1000 according to an exemplary embodiment of the present disclosure may include one or more processors and a main memory and the one or more processors include a data recording module 1300, a version link module 1500, a version retrieving module 1700, and a garbage collection module 1900.

The main memory 1100 according to an exemplary embodiment of the present disclosure may include a database and also include two or more regions. The two or more regions include a first region 1110 and a second region 1120. The first region 1110 and the second region 1120 may be regions which are physically and/or logically divided. A ratio of the first region 1110 and the second region 1120 may vary depending on a kind of database. For example, in a database where a data value is frequently updated, a size of the second region 1120 may be larger than a size of the first region 1110 and in a database where a data value is not frequently updated, the size of the first region 1110 may be larger than the size of the second region 1120. The above description is merely exemplary and the ratio of the sizes of the first region 1110 and the second region 1120 may be arbitrarily determined depending on a structure and a kind of database and a capacity of the main memory 1100.

The database is configured by a data table including columns and rows and stores data. The data may refer to a specific column and row of the data table of the database. The main memory database may include data having one or more versions. The data includes one or more versions and the one or more versions are linked to generate a version chain and represent data. When data included in the database is changed, a new version for the data is generated and the new version is linked to a previous version to reflect the change of data in the database. When the data recorded in the database is read, data corresponding to a transaction is read (for example, a version after a specific time stamp is read or the latest version is read) in accordance with a link of the version chain of the data. The oldest version of the version chain for the data may be located in the first region 1110 of the main memory 1100 and versions after the oldest version of the version chain for the data may be located in the second region 1120. The versions may be configured by a header which identifies the data and the version and a data field including data. The header includes at least one of a flag which represents a usage state of the version, version identification information which identifies the version, a time stamp, and data identification information which identifies data.

The main memory 1100 is configured to store various types of data to support an operation of the computing apparatus 1000. The main memory 1100 may be implemented using an arbitrary type of volatile or non-volatile memory devices, such as a dynamic random access memory (DRAM), a static random access memory (SRAM), an electrically erasable programmable read only memory (EEPROM), an erasable programmable read only memory (EPROM), or a combination thereof.

The data recording module 1300 records data in the main memory 1100. The data recording module 1300 allocates a part of the first region 1110 to a first version which is the oldest version among the plurality of versions of the data to locate the first version in the first region 1110 of the main memory 1100 and allocates a part of the second region 1120 to a second version which is a subsequent version to the first version, among the plurality of versions of the data to locate the second version in the second region 1120 of the main memory 1100. When an initial version of the data is inserted, the data recording module 1300 records the initial version in the first region 1110. When a next version of the inserted data is recorded, the data recording module 1300 records versions after the first version in the second region 1120. The data recording module 1300 records the data in the main memory 1100 to improve the performance of the database to be better than that of the disk database. The data recording module 1300 records a version including a header and a data field in the main memory 1100 to record data. When the data recording module 1300 records a value in a data field of a version, the data recording module 1300 displays that a flag 2100 which represents a usage state of the version is in use to maintain a version consistency between a plurality of clients. When the data recording module 1300 records a value in a data field of a version, the data recording module 1300 displays that the flag 2100 is in use, so that when a client requests the data, a version in which the data is recording may not be read.

The version link module 1500 links the first version and the second version to generate a version chain. The version link module 1500 records version identification information in a header of each version of data to link the version. The version identification information may include information for identifying a next version. For example, the information for identifying a next version may include address value information on a main memory of next version data, information indicating whether there is next version data, and transaction information including the next version data. However, the above description is merely an example, and the information for identifying a next version may include arbitrary information for identifying a version of data on the main memory.

The version retrieving module 1700 reads out data recorded in the main memory 1100. The version retrieving module 1700 retrieves a version which is located in the first region 1110 to identify data. When the version retrieving module 1700 identifies a version which is located in the first region 1110, the version retrieving module 1700 reads out a version which is located in the second region 1120 along a link of a version which is located in the first region 1110. The version retrieving module 1700 scans the first region to identify the data and when there is a next version in accordance with version identification information of a header of the identified data, the version retrieving module 1700 reads out the next version and reads out a version (the latest version) which does not have a subsequent version. The version retrieving module 1700 reads out data recorded in the main memory 1100 in accordance with a request of the client.

In an exemplary embodiment of the present disclosure, when the data recorded in the main memory 1100 is read out, the version retrieving module 1700 can scan only the first region 1110 which is a part of the main memory 1100 to identify the data, so that a scanning amount of the memory is reduced and a usage amount of the processor is reduced. Further, a retrieving range is reduced, thereby increasing a retrieving performance. Further, the garbage collection GC is periodically performed on the first region 1110 so that the first region 1110 is not fragmented, and data is continuously recorded, thereby improving a scanning performance.

The garbage collection module 1900 performs garbage collection on the main memory database. When a predetermined condition is satisfied, the garbage collection module 1900 performs garbage collection on the main memory database. The garbage collection module 1900 may determine to perform the garbage collection based on whether a user request is received, whether a predetermined period has elapsed, whether there are a predetermined number of versions or more for the data (for example, specific data is frequently modified so that the number of versions for the data exceeds 10), whether a usage amount of the processor is equal to or smaller than a predetermined usage amount, or whether an available capacity of the main memory is equal to or smaller than a predetermined amount.

The garbage collection module 1900 may identify versions to be deleted by the garbage collection, among the plurality of versions of data. The garbage collection module 1900 deletes a version other than valid versions among a plurality of versions for the data. The valid version may include the latest version among the plurality of versions of data. When the latest version indicates deletion of data, the garbage collection module may determine that the latest version indicating deletion of data is the invalid version. The versions to be deleted by the garbage collection may include a version excluding at least one the latest version and a version in use among the plurality of versions of data. When the garbage collection is performed, a version which is being recorded by the data recording module 1300 or a version which is being read out by the version retrieving module 1700 is versions in use, to be excluded from versions to be deleted by the garbage collection. Versions other than the valid versions, among the plurality of versions of the data may be deleted by the garbage collection. The garbage collection module 1900 may delete the versions to be deleted from the main memory 1100.

The garbage collection module 1900 may identify versions to be deleted by the garbage collection, among the plurality of versions of data. The garbage collection module 1900 may set a garbage collection time stamp for the garbage collection. The garbage collection time stamp GC-timestamp may include the smallest value from all read time stamps which are being operated. For example, when a plurality of clients requests to read out data, if it is assumed that the read time stamps are 45, 60, 70, and 85, the garbage collection time stamp may be 45. As described above, the garbage collection module 1900 may set the garbage collection time stamp so that a target of the garbage collection is versions which are guaranteed not to be read by any clients. The garbage collection module sets versions having a value which is smaller than that of the garbage collection time stamp to be a target of the garbage collection and performs the garbage collection.

The garbage collection module 1900 performs the garbage collection on the first region and the second region and secondarily performs the garbage collection on the first region after performing the garbage collection on the first region and the second region. After deleting versions excluding valid versions among the plurality of versions of data through the garbage collection, when the oldest version among the plurality of versions which is not deleted is located in the second region 1120, the garbage collection module 1900 may move the oldest version to the first region 1110. The oldest version of the data is always located in the first region 1110 through this operation, so that a high retrieving performance of the database according to an exemplary embodiment of the present disclosure may be maintained after the garbage collection. The garbage collection module 1900 may determine whether the oldest version among the undeleted versions for each data is located in the second region 1120 after scanning the memory to delete versions other than the valid version. The garbage collection module 1900 reads the oldest version located in the second region 1120 among the undeleted versions for each data to record the oldest version in the first region 1110. Further, the garbage collection module 1900 reads the oldest version for each data in the first region 1110 and the second region 1120 and records the read oldest version for each data in the first region 1110 after deleting all versions in the first region 1110.

The main memory database according to an exemplary embodiment of the present disclosure locates the oldest version among the plurality of versions of data in the first region 1110 and locates the later versions in the second region 1120 to scan only the first region without scanning all the main memory in order to retrieve data to identify the data and read the latest version through the version link of the identified data. Therefore, the main memory database according to an exemplary embodiment of the present disclosure may reduce a usage amount of a processor to read and record the data as compared with a main memory database of the related art which records versions of the data in a random location and also improve a reading and recording performance. The main memory database according to an exemplary embodiment of the present disclosure reduces the usage amount of the processor to increase power efficiency of a computing apparatus such as a server. Further, even though the invalid versions are organized through the garbage collection, the main memory database according to an exemplary embodiment of the present disclosure always locates the oldest version in the first region, to maintain an improved retrieving performance, and reduce fragmentation of the main memory, thereby minimizing the lowering of a performance as the time elapses.

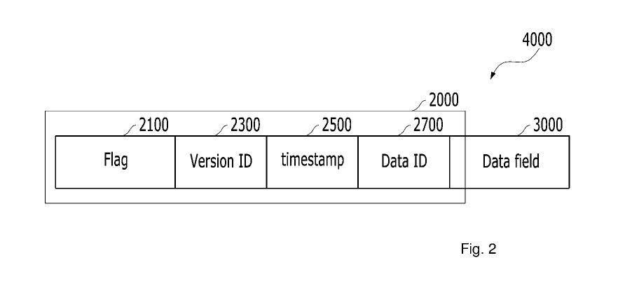

FIG. 2 is a view illustrating a configuration of a version of data according to an exemplary embodiment of the present disclosure.

A version 4000 of the data according to an exemplary embodiment of the present disclosure may include a header 2000 and a data field 3000.

The header 2000 includes at least one of a flag 2100 which represents a usage state of the version, version identification information 2300 which identifies the version, a time stamp 2500, and data identification information 2700 which identifies data.

The flag 2100 may indicate a usage state of the version or whether the version is deleted. The flag 2100 indicates whether the current version is being recorded or read. When the version is currently being recorded in the flag 2100, the version retrieving module 1700 may not read the version. The database according to an exemplary embodiment of the present disclosure provides the flag 2100 as described above to maintain data consistency even when a plurality of clients accesses the database.

The version identification information 2300 may include information for identifying a version. The version identification information 2300 may include information of an address value on a main memory of a next version of the data, information on whether next version data is present, and transaction information including the next version data. However, the above description is merely an example and the version identification information may include arbitrary information for identifying a current version and/or a next version of the data on the main memory.

The time stamp 2500 includes information concerning a time when the version is recorded and information concerning a time of a transaction related with the version. The time stamp 2500 may include a time stamp value at which the version is committed. The time stamp 2500 may include a character string representing a time. The time stamp 2500 may include arbitrary information related with the time for a version.

The data identifying information 2700 includes identification information indicating whether a value recorded in a data field is located in a specific column and row of the data table of the database. The data identification information may include transaction identification information of the data. However, the above description is merely an example and the data identification information 2700 may include arbitrary information for identifying a column and a row of the data table.

The data field 3000 may include a data value. The data value may include an arbitrary type of character strings or numbers, or other arbitrary information.

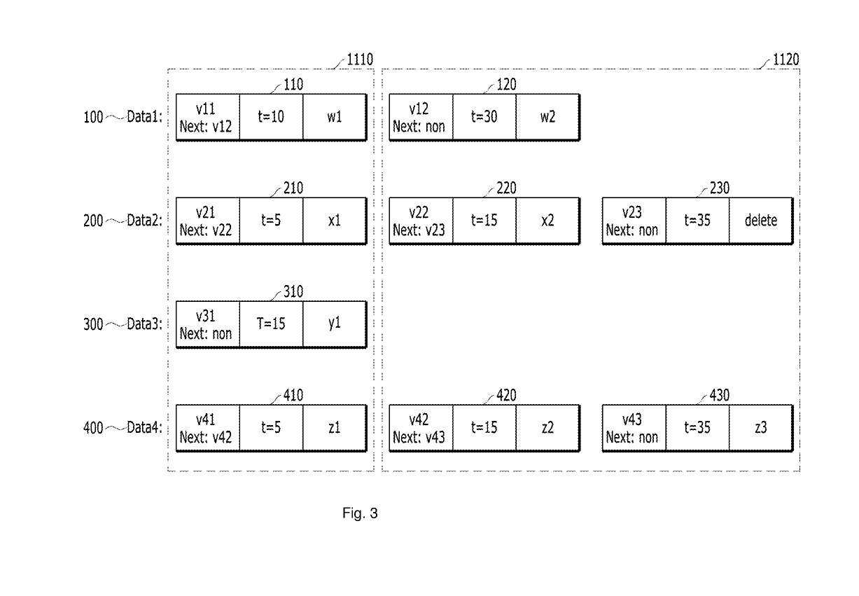

FIG. 3 is a view illustrating a plurality of data including a plurality of versions according to an exemplary embodiment of the present disclosure.

FIG. 3 is an exemplary diagram illustrating that a plurality of data includes a plurality versions to be located in the first region 1110 or the second region 1120 of the main memory. Versions of data of FIG. 3 may have a structure as illustrated in FIG. 2 and some configurations of the header are omitted in FIG. 3.

In an example of FIG. 3, data 1 100 is inserted as a data value w1 at a time stamp (t=10) (a first version 110 of data 1) and updated to be a data value w2 at a time stamp (t=30) (a second version 120 of data 1). Data 2 200 is inserted as a data value x1 at a time stamp (t=5) (a first version 210 of data 2), updated to be a data value x2 at a time stamp (t=15) (a second version 220 of data 2), and deleted at a time stamp (t=35) (a third version 230 of data 2). Data 3 300 is inserted as a data value y1 at a time stamp (t=15) (a first version 310 of data 3). Further, data 4 400 is inserted as a data value z1 at a time stamp (t=5) (a first version 410 of data 4), updated to be a data value z2 at a time stamp (t=15) (a second version 420 of data 4), and updated to be a data value z3 at a time stamp (t=35) (a third version 430 of data 4). The above description is all examples and the time stamp is represented by numbers for convenience sake but may include an arbitrary structure including a time. Further, the data values included in the data field of individual versions are examples and may include arbitrary data values.

As described above, the oldest version (the first version 110, 210, 310, or 410 of each data) among versions of each data 100, 200, 300, or 400 may be located in the first region 1110 of the main memory 1100. Versions 120, 220, 230, 420, and 430 after the oldest version among the versions of data may be located in the second region 1120 of the main memory 1100.

The version retrieving module 1700 scans the first region 1110 to read the oldest version of each data. For example, when a client request data 1, the version retrieving module 1700 scans the first region 1110 to identify the first version 110 of the first data. The version retrieving module 1700 obtains whether there is a second version 120 of the first data and a location thereof by referring to version identification information of the first version 110 of the first data and reads the second version 120 of the first data to provide the second version of the first data to the client based thereon.

In an example of FIG. 3, according to the exemplary embodiment of the present disclosure, the version retrieving module 1700 may scan only the first versions 110, 210, 310, and 410 for four data included in the first region 1110, so that the data retrieving speed may be faster than that of a general main memory database. The general main memory database needs to scan all of the nine versions in an example illustrated in FIG. 3, so that the usage amount of the processor may be larger than that of the present disclosure.

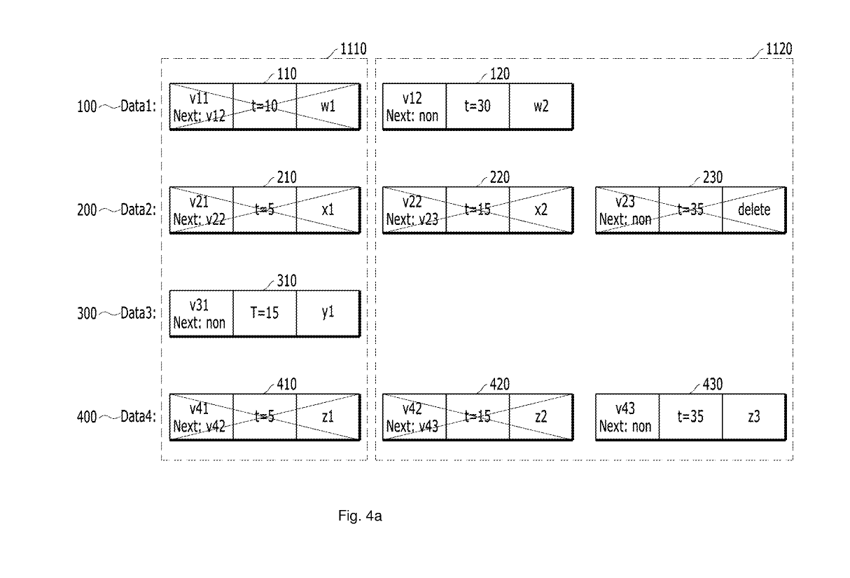

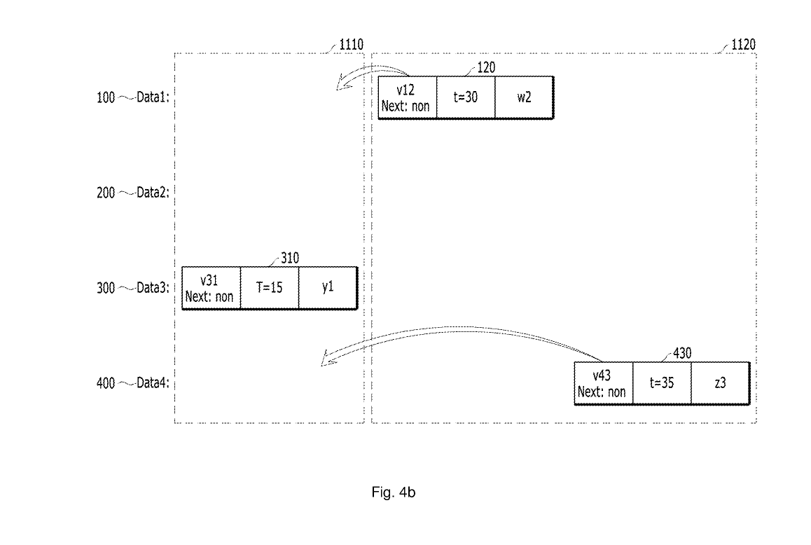

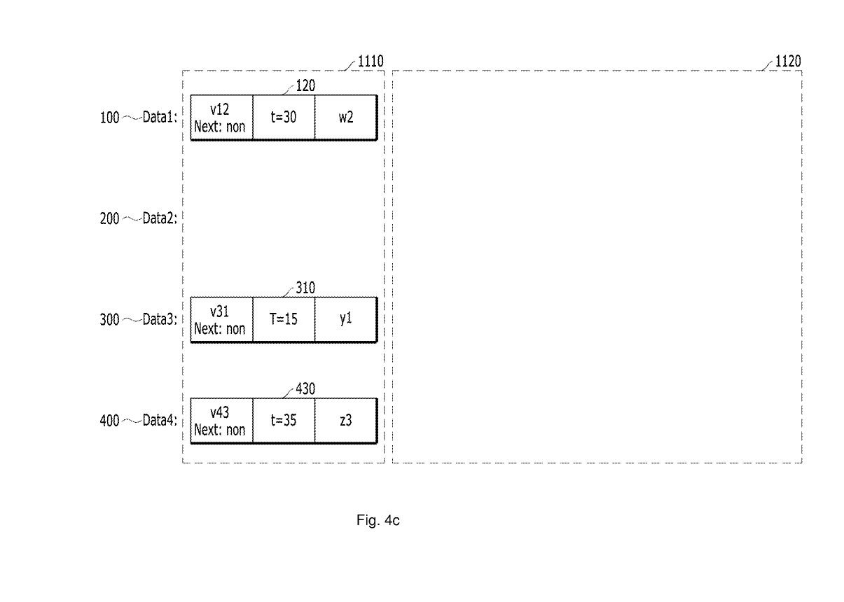

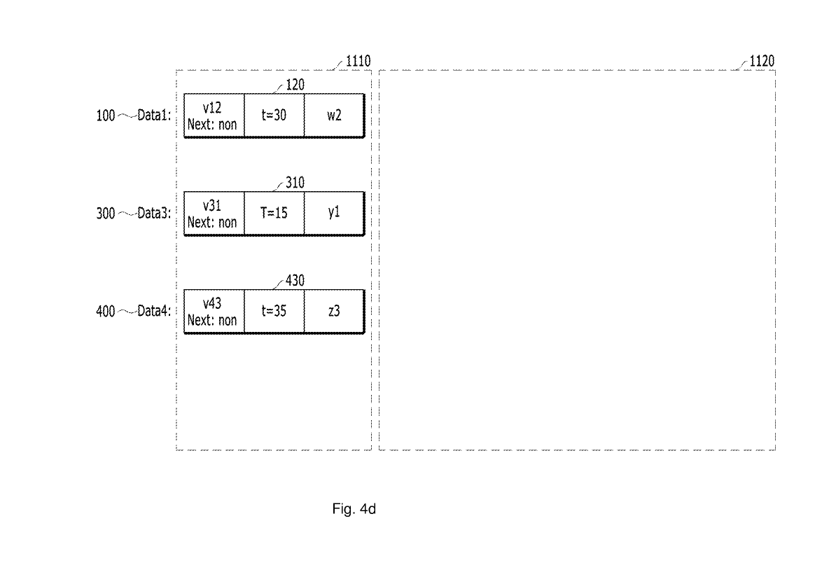

FIGS. 4A to 4D are views illustrating a process of performing garbage collection on a plurality of data including a plurality of versions according to an exemplary embodiment of the present disclosure.

FIG. 4A is an exemplary view illustrating a process of performing garbage collection on an example of data and versions illustrated in FIG. 3.

In the example of FIG. 4A, it is assumed that all versions are targets of the garbage collection without performing a reading operation on all the versions.

The garbage collection module 1900 performs garbage collection on the main memory database. The garbage collection module 1900 may identify versions to be deleted by the garbage collection, among the plurality of versions of data and delete versions which are identified to be deleted.

In an example of FIG. 4A, data 1 100 is inserted as a data value w1 at a time stamp (t=10) (a first version 110 of data 1) and updated to be a data value w2 at a time stamp (t=30) (a second version 120 of data 1). Data 2 200 is inserted as a data value x1 at a time stamp (t=5) (a first version 210 of data 2), updated to be a data value x2 at a time stamp (t=15) (a second version 220 of data 2), and deleted at a time stamp (t=35) (a third version 230 of data 2). Data 3 300 is inserted as a data value y1 at a time stamp (t=15) (a first version 310 of data 3). Further, data 4 400 is inserted as a data value z1 at a time stamp (t=5) (a first version 410 of data 4), updated to be a data value z2 at a time stamp (t=15) (a second version 420 of data 4), and updated to be a data value z3 at a time stamp (t=35) (a third version 430 of data 4). The above description is all examples and the time stamp is represented by numbers for convenience sake but may include an arbitrary structure including a time. Further, the data values included in the data field of individual versions are examples and may include arbitrary data values.

In this case, the garbage collection module 1900 may identify that versions excluding at least one of the latest version of the data or a version in use are versions to be deleted. In FIG. 4A, since it is assumed that there is no version in use, the first version 110 of data 1 has a second version 120 of data 1, so that the first version 110 is a target to be deleted. Since a third version of data 2 indicates delete of data, the first, second, and third versions 210, 220, and 230 of data 2 are targets to be deleted by the garbage collection. Since there is a third version 430 of data 4, first and second versions 410 and 420 of data 4 are targets to be deleted.

In an example of FIG. 4B, the garbage collection module 1900 may delete the first version 110 of data 1, the first, second, and third versions 210, 220, and 230 of data 2, and the first and second versions 410 and 420 of data 4 which are targets to be deleted by the garbage collection. Further, when the oldest version among the plurality of versions of data is located in the second region 1120, the garbage collection module 1900 may move the oldest version to the first region 1110. In an example of FIG. 4B, since the first version 120 of data 1 and the third version 430 of data 4 are the oldest versions among the versions of data 1 and data 4 or located in the second region 1120, the garbage collection module 1900 may move the second version 120 of data 1 and the third version 430 of data 4 to the first region 1110.

The garbage collection module 1900 reads the oldest version located in the second region 1120 among the undeleted versions for each data to record the oldest version in the first region 1110. Further, the garbage collection module 1900 reads the oldest version for each data in the first region 1110 and the second region 1120 and records the read oldest version for each data in the first region 1110 in the first region 1110 after deleting all versions in the first region 1110.

In an example of FIG. 4C, the garbage collection module 1900 reads the second region 1120 to move the second version 120 of data 1 and the third version 430 of data 4 which are located in the second region 1120 to the first region 1110. Further, in an example of FIG. 4D, the garbage collection module 1900 reads the first region 1110 and the second region 1120 to read the first version 110 of data 1, the first version 310 of data 3, and the third version 430 of data 4 which are the oldest versions among the plurality of versions of data and deletes the versions of the first region 1110, and then records the first version 110 of data 1, the first version 310 of data 3, and the third version 430 of data 4 in the first region 1110. Through the above-described operation, a discontinuous region of the first region 1110 caused by deleting data 2 200 is removed to reduce the fragmentation of the first region.

Even though the invalid versions are organized through garbage collection, the main memory database according to an exemplary embodiment of the present disclosure always locates the oldest version in the first region, to maintain an improved retrieving performance, and reduce fragmentation of the main memory, thereby minimizing the lowering of a performance as a time elapses.

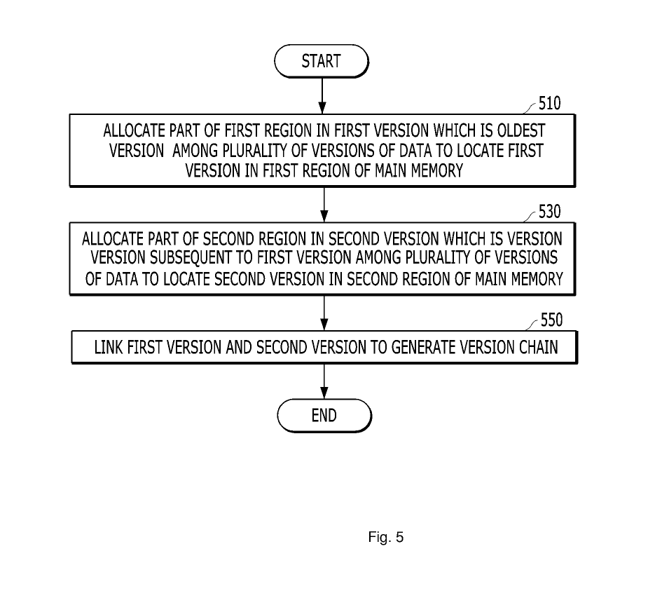

FIG. 5 is a flowchart illustrating a management method of a main memory database according to an exemplary embodiment of the present disclosure.

A management method of a main memory database according to an exemplary embodiment of the present disclosure may be performed in a computing apparatus 1000 including one or more processors and a main memory which stores commands executable in the processors.

The main memory 1100 includes two or more regions including a first region 1110 and a second region 1120.

The data recording module 1300 allocates a part of the first region 1110 to a first version which is the oldest version among a plurality of versions of data to locate the first version in the first region 1110 of the main memory 1100 in step 510. When the first version of the data is inserted, the data recording module 1300 records the first version in the first region 1110.

The data recording module 1300 allocates a part of the second region 1120 to a second version which is a subsequent version to the first version among a plurality of versions of data to locate the second version in the second region 1120 of the main memory in step 530. When a next version of the inserted data is recorded, the data recording module 1300 records versions after the first version in the second region 1120.

The version link module 1500 links the first version and the second version to generate a version chain in step 550. The version link module 1500 records version identification information in a header of each version of data to link the version. The version identification information may include information for identifying a next version.

The main memory database according to an exemplary embodiment of the present disclosure locates the oldest version among the plurality of versions of data in the first region 1110 and locates the later versions in the second region 1120 to scan only the first region without scanning all the main memory in order to retrieve data to identify the data and read the latest version through the version link of the identified data. Therefore, the main memory database according to an exemplary embodiment of the present disclosure may reduce a usage amount of a processor to read and record the data as compared with a main memory database of the related art which records versions of the data in a random location and also improve a reading and recording performance. The main memory database according to an exemplary embodiment of the present disclosure reduces the usage amount of the processor to increase power efficiency of a computing apparatus such as a server. Further, even though invalid versions are organized through garbage collection, the main memory database according to an exemplary embodiment of the present disclosure always locates the oldest version in the first region, to maintain an improved retrieving performance, and reduce fragmentation of the main memory, thereby minimizing the lowering of a performance as a time elapses.

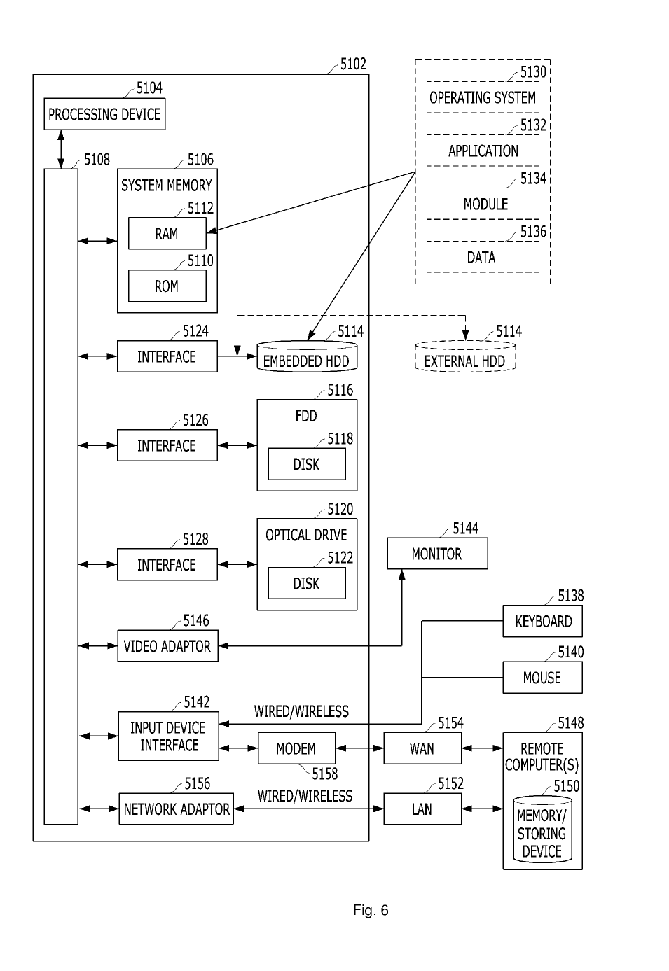

FIG. 6 illustrates a simple and general schematic view of an exemplary computing environment in which exemplary embodiments of the present disclosure are embodied.

Even though the present disclosure is generally described in regards to a computer executable instruction which may be executed in one or more computers, it is obvious to those skilled in the art that the present disclosure may be implemented by being coupled with other program modules and/or a combination of hardware and software.

Generally, the program module includes a routine, a program, a component, a data structure, or the like which performs a specific task or implements a specific abstract data type. Further, those skilled in the art may understand well that the method of the present disclosure may be embodied not only by a single processor or a multi-processor computer system, a mini computer, and a main frame computer, but also a personal computer, a hand-held computing apparatus, microprocessor based or programmable home appliances (which may be connected to one or more related devices to be operated), and other computer system configurations.

The described exemplary embodiments of the present disclosure may also be embodied in a distributed computing environment in which some tasks are performed by remote processing devices which are connected to each other through a communication network. In the distributed computing environment, a program module may be located in both local and remote memory storing devices.

Generally, a computer includes various computer readable media. If a medium is accessible by the computer, the medium may be a computer readable medium and the computer readable medium includes a volatile or non-volatile medium, a transitory or non-transitory medium, and a mobile or non-mobile medium. As an example which is not limited thereby, the computer readable medium may include a computer storage medium and a communication medium. The computer storage medium includes a volatile or non-volatile medium, a transitory or non-transitory medium, and a mobile or a non-mobile medium which are implemented by an arbitrary method or technique which stores information such as a computer readable instruction, a data structure, a program module or other data. The computer storage medium includes a RAM, a ROM, an EEPROM, a flash memory, or other memory techniques, a CD-ROM, a digital video disk (DVD), or other optical disk storing devices, a magnetic cassette, a magnetic tape, a magnetic disk storing device, or other magnetic storing devices, or other arbitrary media which are accessed by a computer and are used to store desired information, but is not limited thereto.

The communication medium generally implements a computer readable instruction, a data structure, a program module, or other data in a modulated data signal such as a carrier wave or other transport mechanisms and includes all information transfer media. The term “modulated data signal” refers to a signal in which one or more of the properties of the signal are set or changed to encode information in the signal. As an example which is not limited thereby, the communication medium includes a wired medium such as a wired network or direct wired connection and a wireless medium such as sound, RF, infrared ray, or other wireless medium. It is considered that a combination of any of the above-mentioned media may also be included in the scope of the computer readable medium.

An exemplary environment 5100 including a computer 5102 which implements various aspects of the present disclosure is illustrated and the computer 5102 includes a processing device 5104, a system memory 5106, and a system bus 5108. The system bus 5108 connects system components including a system memory 5106 (not limited thereto) to the processing device 5104. The processing device 5104 may be an arbitrary processor among various commercial processors. A dual processor and other multiprocessor architectures may also be used as the processing device 5104.

The system bus 5108 may be any of the several types of bus structures which are additionally connected to a local bus which uses any one of a memory bus, a peripheral device bus, and various commercial bus architectures. The system memory 5106 includes a read only memory (ROM) 5110 and a random access memory (RAM) 5112. A basic input/output system (BIOS) is stored in a non-volatile memory 5110 such as a ROM, an EPROM, and an EEPROM and the BIOS includes a basic routine which assists to transmit information between components in the computer 5102 while the computer is activated. The RAM 5112 may include a fast RAM such as a static RAM for caching data.

The computer 5102 further includes an embedded hard disk drive (HDD) 5114 (for example, EIDE, SATA) which may also be configured as an external disk in an appropriate chassis (not illustrated), a magnetic floppy disk drive (FDD) 5116 (for example, to read data from a portable diskette 5118 or record data therein), and an optical disk drive 5120 (for example, to read a CD-ROM disk 5122 or read data from other high quantity optical media such as a DVD or record data therein). The hard disk drive 5114, the magnetic disk drive 5116, the optical disk drive 5120 may be connected to the system bus 5108 through a hard disk drive interface 5124, a magnetic disk drive interface 5126, and an optical drive interface 5128. The interface 5124 for implementing an external drive includes at least one or both of universal serial bus (USB) and IEEE 1394 interface technique.

These drives and a computer readable medium related therewith provide non-volatile storage of data, a data structure, a computer executable instruction, or the like. In the case of the computer 5102, the drive and the medium correspond to storing arbitrary data as an appropriate digital type. In the description of the computer readable medium, an HDD, a portable magnetic disk, and a portable optical medium such as a CD or a DVD have been mentioned. However, it is well known to those skilled in the art that other types of computer readable medium such as a zip drive, a magnetic cassette, a flash memory card, a cartridge, or the like may also be used in an exemplary operating environment and the arbitrary medium may include a computer executable instruction which performs the methods of the present disclosure.

A large number of program modules including an operating system 5130, one or more application programs 5132, other program modules 5134, and program data 5136 may be stored in the drive and the RAM 5112. The operating system, the application, module and/or all or a part of data are also cached by the RAM 5112. It is obvious that the present disclosure may be implemented by various commercially applicable operating systems or a combination of operating systems.

A user may input a command and information to the computer 5102 through one or more wired/wireless input devices, for example, a pointing device such as a keyboard 5138 and a mouse 5140. Other input devices (not illustrated) may include a microphone, an IR remote controller, a joystick, a game pad, a stylus pen, a touch screen, or the like. These and other input devices are sometimes connected to the processing device 5104 through an input device interface 5142 which is connected to the system bus 5108, but may be connected by a parallel port, an IEEE 1394 serial port, a game port, a USB port, an IR interface, or other interfaces.

A monitor 5144 or other type of display device is also connected to the system bus 5108 through an interface such as a video adaptor 5146. In addition to the monitor 5144, a computer generally includes other peripheral output devices (not illustrated) such as a speaker or a printer.

The computer 5102 may operate in a networked environment using logical connection of remote computer(s) 5148 to one or more remote computers through wired and/or wireless communication. The remote computer(s) 5148 may be a workstation, a server computer, a router, a personal computer, a portable computer, a microprocessor based amusement machine, a peer device, or other general network nodes and generally, includes a large number of or all the components which have been described for the computer 5102. However, for the purpose of simplicity, only a memory storing device 5150 is illustrated. The illustrated logical connection includes wired/wireless connection to a local area network (LAN) 5152 and/or larger network, for example, a wide area network (WAN) 5154. The LAN and WAN networking environments are general in an office and a company and facilitate enterprise-wide computer network such as intranet and these are all connected to a worldwide computer network, for example, the Internet.

When the computer is used in the LAN networking environment, the computer 5102 is connected to a local network 5152 through a wired and/or wireless communication network interface or an adaptor 5156. The adaptor 5156 facilitates wired or wireless communication to the LAN 5152 and the LAN 5152 also includes a wireless access point provided therein to communicate with the wireless adaptor 5156. When the computer is used in the WAN networking environment, the computer 5102 has other means, for example, includes a modem 5158 or is connected to a communication server on the WAN 5154, or uses Internet to set communication through the WAN 5154. The modem 5158 which may be an embedded or external, and wired or wireless device is connected to the system bus 5108 through the serial port interface 5142. In a networked environment, program modules described for the computer 5102 or a part thereof may be stored in the remote memory/storing device 5150. It is understood that the illustrated network connection is an example and other means to set a communication link between computers may be used.

The computer 5102 performs operations to communicate with an arbitrary wireless device or entity which is disposed through wireless communication to operate, for example, a printer, a scanner, a desktop and/or portable computer, a portable data assistant (PDA), a communication satellite, arbitrary equipment or location related with a wireless detectable tag, and a telephone. This includes at least Wi-FI and Bluetooth wireless technology. Therefore, communication may be a previously defined structure such as a network of the related art or simply ad hoc communication between at least two devices.

Wi-Fi (wireless fidelity) may allow connection to the Internet without using a wire. The Wi-Fi is a wireless technique such as a cell phone which allows such a device, for example, a computer to transmit and receive data indoor and outdoor, that is, in any place within a coverage of a base station. The Wi-Fi network uses a wireless technology called IEEE 802.11 (a,b,g, or the like) to provide safe, reliable, and fast wireless connection. Wi-Fi is used to connect computers to each other or to the Internet, and a wired network (IEEE 802.3 or Ethernet is used). The Wi-Fi network operates at a 11 Mbps (802.11a) or 54 Mbps (802.11b) data rate in an unauthorized wireless band of 2.4 and 5 GHz or operates in a product including both bands (dual band).

Those skilled in the art may understand that information and signals may be represented using various arbitrary technologies and techniques. For example, data, indications, commands, information, signals, bits, symbols, and chips which may be referred in the above description may be represented by voltages, currents, electromagnetic waves, magnetic fields or particles, optical fields or particles, or an arbitrary combination thereof.

Those skilled in the art may understand that various exemplary logical blocks, modules, processors, units, circuits, and algorithm steps which have been described with respect to the exemplary embodiments disclosed herein may be implemented by electronic hardware, various types of programs (for the convenience, referred to as “software” here), a design code, or a combination thoseof. In order to clearly describe compatibility of hardware and software, various exemplary components, blocks, modules, circuits, and steps are generally described above with respect to functions thoseof. Whether these functions are implemented as hardware or software is determined depending on design restrictions which are applied to a specific application and the entire system. Those skilled in the art may implement the function, which is described by various methods, of the specific application but the implementation determination is not interpreted to depart from the scope of the present disclosure.

Various exemplary embodiments suggested herein may be implemented by a method, a device, or a standard programming and/or an article using an engineering technique. The term “article” includes a computer program which is accessible from an arbitrary computer readable device, a carrier or a medium. For example, the computer readable medium includes a magnetic storing device (for example, a hard disk, a floppy disk, or a magnetic strip), an optical disk (for example, a CD or a DVD), a smart card, and a flash memory device (for example, an EEPROM, a card, a stick, or a key drive), but is not limited thereto. Further, various storage media suggested herein include one or more devices for storing information and/or other machine readable media. The term “machine readable medium” includes a wireless channel which stores, contains, and/or transmits command(s) and/or data and various other media, but is not limited thereto.

It should be understood that a specific order or a hierarchical structure of steps in suggested processes is an example of exemplary approaches. It should be understood that a specific order or a hierarchical structure of steps in the processes may be rearranged within the scope of the present disclosure, based on a design priority. The accompanying method claims provide elements of various steps in the order of sample, but the claims are not meant to be limited to the suggested specific order or hierarchical structure.

Description of the suggested exemplary embodiment is provided to allow those skilled in the art to use or embody the present disclosure. Various modifications of the exemplary embodiments may be apparent to those skilled in the art and general principles defined herein may be applied to other exemplary embodiments without departing from the scope of the present disclosure. Therefore, the present disclosure is not limited to the exemplary embodiments suggested herein, but interpreted in a broadest range which is consistent with principles suggested herein and new features.

What is claimed is:

1. A management method of a main memory database which is performed in a computing apparatus including one or more processors and a main memory which stores commands executable in the processors, the main memory including two or more regions which include a first region and a second region, the method comprising:
allocating a part of the first region to a first version which is the oldest version among a plurality of versions of data to locate the first version in the first region of the main memory;
allocating a part of the second region to a second version which is a subsequent version to the first version among a plurality of versions of data to locate the second version in the second region of the main memory; and
linking the first version and the second version to generate a version chain,
wherein the first version and the second version are configured by a header which identifies data and a version and a data field including data.

2. The method of claim 1, wherein the header includes at least one of a flag which represents a usage state of the version, version identification information which identifies the version, a time stamp, and data identification information which identifies data.

3. The method of claim 1, further comprising:
retrieving a version which is located in the first region when the data of the main memory database is retrieved.

4. The method of claim 3, further comprising:
reading the second version located in the second region along a link of a version located in the first region when a version which is located in the first region is identified.

5. The method of claim 1, further comprising:
performing garbage collection (GC) on the main memory database.

6. The method of claim 5, wherein the performing of garbage collection includes:
identifying versions to be deleted by the garbage collection among the plurality of versions of the data;
deleting versions which are identified to be deleted; and
moving the oldest version to the first region when the oldest version among the plurality of versions of the data is located in the second region, based on the version of the data.

7. The method of claim 6, wherein versions to be deleted by the garbage collection include versions excluding at least one of the latest version and a version in use among the plurality of versions of data.

8. The method of claim 1, wherein the first region is a region in which the oldest version of the version chain for the data is located and the second region is a region in which versions after the oldest version of the version chain for the data are located.

9. A computing apparatus including a main memory database, the apparatus comprising:
one or more processors; and
a main memory which stores a database and includes two or more regions including a first region and a second region,
wherein the one or more processors include:
a data recording module which allocates a part of the first region to a first version which is the oldest version among a plurality of versions of data to locate the first version in the first region of the main memory and allocates a part of the second region to a second version which is a subsequent version to the first version among a plurality of versions of data to locate the second version in the second region of the main memory; and
a version link module which links the first version and the second version to generate a version chain, and
the first version and the second version are configured by a header which identifies data and a version and a data field including data.

10. A computer program stored in a computer readable medium, including a plurality of commands executed by one or more processors, the main memory including two or more regions which include a first region and a second region, the computer program comprising:
a command for allocating a part of the first region to a first version which is the oldest version among a plurality of versions of data to locate the first version in the first region of the main memory;
a command for allocating a part of the second region to a second version which is a subsequent version to the first version among a plurality of versions of data to locate the second version in the second region of the main memory; and
a command for linking the first version and the second version to generate a version chain,
wherein the first version and the second version are configured by a header which identifies data and a version and a data field including data.
